(19) United States
(12) Patent Application Publication
(10) Pub. No.: US 2022/0370955 A1
(43) Pub. Date: Nov. 24, 2022

(54) A METHOD FOR CAPTURING CARBON DIOXIDE

(71) Applicants: Joy Vadakkan Thomas, Irinjalakud (IN); Jessiya Joy, Irinjalakud (IN); Gopika Kalapurakkal Narayanankutty, Irinjalakuda (IN)

(72) Inventors: Joy Vadakkan Thomas, Irinjalakud (IN); Jessiya Joy, Irinjalakud (IN); Gopika Kalapurakkal Narayanankutty, Irinjalakuda (IN)

(21) Appl. No.: 17/767,353

(22) PCT Filed: Oct. 16, 2020
(86) PCT No.: PCT/IN2020/050883

§ 371 Date: Apr. 7, 2022

(30) Foreign Application Priority Data
Oct. 18, 2019 (IN) 201941042481

(51) Int. Cl. B01D 53/62; B01D 53/96

(52) U.S. Cl. CPC B01D 53/62; B01D 53/96; B01D 2251/606; B01D 2257/504; B01D 2258/06

(57) ABSTRACT

A process for capture of carbon dioxide comprising the steps of contacting the carbon dioxide with at least one metal carbonate in an aqueous organic solvent at a predetermined temperature.

### FIELD OF THE INVENTION

The present invention relates to a method for capturing carbon dioxide. More particularly, it relates to a very simple and green method for capturing carbon dioxide from air and gas streams.

### BACKGROUND OF THE INVENTION

A major share (˜80%) of today's global energy is generated by burning of fossil fuels. Burning these fuels release carbon dioxide gas into the atmosphere. Carbon dioxide is a greenhouse gas and its increased levels in the atmosphere have contributed to global warming and climate change. Currently the global average atmospheric CO₂ level are nearly 410 parts per million and this level is higher than the level of CO₂ at any time in the past 800,000 years and is high enough to cause a global warming of more than 2 degrees. Hence reducing CO₂ concentration in the atmosphere has become one of the key environmental issues of our age.

According to the Paris climate accord, set within the United Nations Framework Convention on Climate Change (UNFCCC), we must curb global warming below 2° C. To realize such a goal, we must remove about 18 billion tons of carbon dioxide from the atmosphere every year.

One of the conventional technique for carbon dioxide capture and storage (CCS) is by direct capture from CO₂ flue gas streams generated by different energy intensive industries (iron, steel and cement industries, power plants, oil refineries, etc.) and the process consists of pumping the gas stream through a system that either liquefies carbon dioxide gas and stores it or chemically turns it either into an inert or useful substance. The total CO₂ concentration in flue gas is typically 10-15%. The CCS process applied to flue gas emissions from large power plants or industrial facilities allows the fossil fuels to be used with low emissions of CO₂. Application of CCS technologies to biomass derived energy sources would allow net removal of CO₂ from the atmosphere, often referred to as ‘negative emissions’, by capturing and storing the atmospheric CO₂ taken up by the biomass.

In contrast to CCS, which captures CO₂ only from flue stacks, direct air capture (DAC) refers to a range of technologies that can capture large quantities of CO₂ directly from atmospheric air. As DAC deals with an extremely low concentration of CO₂ (˜0.041%), chemisorbent materials have proven to be much more effective for DAC processes. High-carbon energy sources are not viable options for powering DAC systems, because their CO₂ emissions may exceed the amount of CO₂ captured. The DAC technology is currently not an economically viable approach to mitigate climate change.

Many technologies have been utilized for direct air capture (DAC) and the use of aqueous sodium hydroxide as sorbent is one of the most promising approaches. Commercial techniques employ large fans to push ambient air through NaOH(aq) solutions; CO₂ gas present in air react with NaOH to form Na₂CO₃. The Na₂CO₃ is then reacted with solid Ca(OH)₂ to regenerate the solvent along with the formation of CaCO₃ crystals. Finally, CaCO₃ crystals are calcined at temperatures above 700° C. to form calcium oxide along with the release of CO₂ as a concentrated gas. The Ca(OH)₂ is finally regenerated by mixing calcium oxide with water, a process known as slaking of lime, thereby closing the cycle. The energy consumption for the whole process has been calculated to be 350 kJ/mole of CO₂ captured. Another chemical process for CO₂ removal, the basic process of which was patented in 1930, involves reversible reaction of an aqueous solution of non-volatile amine such as mono-ethanolamine, diethanolamine (DEA), etc., with acidic gases like carbon dioxide, sulphur dioxide and hydrogen sulphide. The whole reaction is carried out at ambient temperature. The amine and CO₂ are regenerated by reacting with water vapor at 100-160° C. Advantages of the process are low power requirement due to operation at ambient pressure, high selectivity for adsorption of acidic gases etc. Disadvantages of chemical scrubbing with amines are (i) solvent degradation (ii) corrosive properties of liquid amines, (iii) regeneration of the amine is energy intensive, (iv) during regeneration at high temperature there is a chance that some amine may be released into the environment, (v) scale up problems, etc.

In another method of CO₂ capture, the gas stream containing CO₂ gas is passed through anion-exchange resins. These resins are composed of cross-linked organic polymer chains that have the positively charged quaternary amine groups tethered to them and mobile negative ions such as hydroxide groups that are electrostatically bound to positive ionic groups. These resins absorb carbon dioxide when dry and release it when moist.

Membrane separation methods for CO₂ capture are based on the principle that gases diffuse through the membranes at different speeds. A variety of polymers can be used as membranes. A good membrane is highly permeable to smaller molecules such as CO₂, and impermeable to larger molecules such as CH₄. The aim is to achieve the highest possible permeability with high selectivity. For membranes typically used, the permeability of CO₂ is about twenty times higher than CH4.

Thus commercialization of any one these technologies still faces substantial challenges not only in the final technological and processes aspects but also in the capabilities of the capture materials themselves. The whole CO₂ capture and storage technology must be inexpensive and feasible at huge scale to be economically viable. Therefore, in recent years research efforts by many groups have been focused on the development of energy efficient technologies for CO₂ capture.

Accordingly, there is a substantial need to overcome the disadvantages associated with the known processes for capture of carbon dioxide and for a simple, cheap and green process for the same.

### SUMMARY OF THE INVENTION

The present invention provides a process for capture of carbon dioxide comprising the step of contacting the carbon dioxide with at least one metal carbonate in an aqueous organic solvent at a predetermined temperature.

### DESCRIPTION OF THE INVENTION

The present invention provides a process for capture of carbon dioxide from air/atmosphere and/or from gas streams. The process is relatively fast and involves the use of inexpensive, non-toxic and readily available raw materials.

The present invention relates to a process for capture of carbon dioxide comprising the steps of contacting the carbon dioxide with at least one metal carbonate in an aqueous-organic solvent at a predetermined temperature.

In an embodiment of the invention, the ratio of CO₂ to metal carbonate is in the range of 1-2:1 molar equivalents. The CO₂ gas (1-2 moles) is passed through the aqueous organic solvent (1000 ml) containing water in the molar ratio range of 1-2.

The predetermined temperature is in the range of −50° C. to 100° C. is preferred.

The metal carbonate and the reaction temperature are chosen such that metal bicarbonate(s) formed is/are stable at the reaction temperature chosen:
(i) like carbonates of alkali metals (M₂CO₃, where M is an alkali metal cation). The metal carbonate chosen is selected from, but not limited to, Na₂CO₃, K₂CO₃, Rb₂CO₃ and/or Cs₂CO₃.
(ii) like carbonates of alkaline earth metals (MCO₃, where M is an alkaline earth metal cation). The metal carbonate chosen is selected from, but not limited to, MgCO₃, CaCO₃, SrCO₃ and/or BaCO₃. The solid bicarbonates (M(HCO₃)₂) of above alkaline earth metals are unstable at ordinary temperatures and hence in such cases a low reaction temperature selected from the range −50° C. to 10° C. is preferred.
   In the case of alkali metal salts, the CO₂ combines with water and M₂CO₃ to form solid MHCO₃, according to the following reaction.

M₂CO₃+H₂O+CO₂→2MHCO₃

In the case of alkaline metal salts, the CO₂ combines with water and MCO₃ to form solid M(HCO₃)₂, according to the following reaction.

MCO₃+H₂O+CO₂→M(HCO₃)₂

When the desired amount of carbon dioxide has been removed as MHCO₃/M(HCO₃)₂, the unreacted M₂CO₃/MCO₃, if any, and the MHCO₃/M(HCO₃)₂ formed in the reaction are removed by simple filtration. The solubility of MHCO₃/M(HCO₃)₂ and M₂CO₃/MCO₃ in the organic solvent should be preferably very low so as to retrieve it by simple filtration. The organic solvent is recycled to capture fresh carbon dioxide. Thus, the present invention provides “green” method for the capture of carbon dioxide from air/atmosphere and/or gas streams.

The organic solvent is selected from, but not limited to, alcohols, ketones, aldehydes, ethers, aliphatic and aromatic nitriles, aliphatic hydrocarbons like hexane, aromatic hydrocarbons like benzene, toluene. Since the solubilities of both M₂CO₃ and MHCO₃ or MCO₃ and M(HCO₃)₂ in most organic solvents are very low, these can be easily filtered from such organic solvents and the organic solvent can be reused or recycled.

In a preferred process of this invention, an organic solvent is taken in a vessel fitted with an outlet tube and inlet tube. Required amount of M₂CO₃ and H₂O is then added to the organic solvent in the vessel and CO₂ containing gas stream/air is passed through the inlet tube to the suspension of M₂CO₃ in organic solvent containing water under constant stirring. The outlet tube is kept under oil to prevent the entry of moisture to the reaction vessel. The temperature is generally below 50° C., preferably ambient temperature. When most of M₂CO₃ has been converted to MHCO₃ the reaction was stopped. The unreacted M₂CO₃, if any, and MHCO₃ formed in the reaction were collected by simple filtration. The organic solvent can be reused to capture fresh CO₂.

The method of this invention can be done with any organic solvent which is not acidic enough to react with the M₂CO₃ or the MHCO₃. The M₂CO₃ and CO₂ gas can be regenerated by the thermal decomposition of MHCO₃. The water formed during the thermal decomposition of MHCO₃ can be removed by a cold trap to get a concentrated stream of dry CO₂ gas.

2NaHCO₃ [symbol] Na₂CO₃+H₂O+CO₂

Alkali metal carbonates like sodium carbonate or potassium carbonate are cheap and environmentally friendly. Thus, the present invention provides ‘green’ and economically viable method for capturing CO₂ from gas streams. The CO₂ capturing method of the present invention can be used with an alkaline fuel cell (AFC) to remove the CO₂ gas present in the air stream supplied at the cathode

### Examples

The following experimental examples are illustrative of the invention but not limitative of the scope thereof:

### Example

About 60 ml of ethanol containing 2 g of water was taken in a flask fitted with an inlet tube and outlet tube. Then about 15 g anhydrous Na₂CO₃ was added to the flask and the gas stream/air containing CO₂ gas was passed through the suspension under constant stirring. The whole reaction was conducted at room temperature. The outlet tube was kept under oil to prevent entry of moisture to the reaction vessel. When most of the Na₂CO₃ was converted to NaHCO₃ the reaction was stopped by stopping the gas flow. The Na₂CO₃ left unreacted and NaHCO₃ formed in the reaction were separated from the organic solvent by simple filtration under dry atmosphere.

The foregoing description of the invention has been set merely to illustrate the invention and is not intended to be limiting. Since the modifications of the disclosed embodiments incorporating the spirit and substance of the invention may occur to the person skilled in the art, the invention should be construed to include everything within the scope of the disclosure.

1. A process for capturing carbon dioxide, comprising the steps of:
contacting the carbon dioxide with at least one metal carbonate in an aqueous organic solvent at a predetermined temperature.

2. The process as claimed in claim 1, wherein a ratio of CO₂ to metal carbonate is in a range of 1-2:1 molar equivalents.

3. The process as claimed in claim 1, wherein the predetermined temperature is in a range of −50° C. to 100° C.

4. The process as claimed in claim 1, wherein the organic solvents are selected from the group consisting of alcohols, ketones, aldehydes, ethers, aliphatic and aromatic nitriles, aliphatic hydrocarbons, aromatic hydrocarbons and combinations thereof.

5. The process as claimed in claim 1, wherein the at least one metal carbonate is selected from the group consisting of carbonates of alkali metals, alkaline earth metals and combinations thereof.

6. The process as claimed in claim 5, wherein the alkali metal carbonates and alkaline earth metal carbonates are selected from the group consisting of Na₂CO₃, K₂CO₃, Rb₂CO₃, CS₂CO₃, MgCO₃, CaCO₃, SrCO₃, BaCO₃ and combinations thereof.

7. The process as claimed in claim 1, further comprising the step of conducting a simple filtration to remove any metal bicarbonate by-products and unreacted metal carbonates that have been formed as a result of the initial step.

8. The process as claimed in claim 7, wherein the organic solvent is recycled to capture fresh carbon dioxide.

9. The process as claimed in claim 4, wherein the aliphatic hydrocarbons are hexanes.

10. The process as claimed in claim 4, wherein the aromatic hydrocarbons are selected from the group consisting of benzene, toluene and combinations thereof.
